(19) United States
(12) Patent Application Publication
(10) Pub. No.: US 2016/0124876 A1
(43) Pub. Date: May 5, 2016

(54) METHODS AND SYSTEMS FOR NOTICING COMPLETION OF READ REQUESTS IN SOLID STATE DRIVES

(71) Applicant: HGST Netherlands B.V., Amsterdam (NL)

(72) Inventors: Dejan VUCINIC, San Jose, CA (US); Ashish SINGHAI, Los Altos, CA (US); Ashwin NARASIMHA, Sunnyvale, CA (US)

(21) Appl. No.: 14/527,223

(22) Filed: Oct. 29, 2014

(51) Int. Cl. G06F 13/28; G06F 13/40

(52) U.S. Cl. CPC G06F 13/28; G06F 13/4027

(57) ABSTRACT

The present disclosure relates to methods and systems for performing operations in a communications protocol. An example method can include submitting a request for a queue entry representing a command from a host comprising a request for data stored at a storage location; receiving the command from the host; and executing the command. The method can include providing a first set of the requested data, and providing a control signal to the host before providing a second set of the requested data. The control signal can indicate that a transmission of the requested data will complete.

### CROSS-REFERENCE TO RELATED APPLICATIONS

This application is related to U.S. patent application Ser. No. 14/466,538, filed on Aug. 22, 2014, entitled “ACK-LESS PROTOCOL FOR NOTICING COMPLETION OF READ REQUESTS” and U.S. patent application Ser. No. 14/466,515, filed on Aug. 22, 2014, entitled “DOORBELL-LESS ENDPOINT-INITIATED PROTOCOL FOR STORAGE DEVICES,” the contents of which are incorporated herein by reference in their entirety.

### FIELD OF THE DISCLOSURE

The present disclosure relates to systems and methods for implementing a communications protocol for a storage media interface.

### RELATED DISCLOSURE

A communications protocol for a storage media interface specifies how a controller on a storage medium receives commands for processing from a host over an interface. To enable faster adoption and interoperability of storage media connected to a host over a peripheral component interconnect express (PCIe) bus, industry participants have defined a communications protocol known as the non-volatile memory express (NVMe) standard. NVMe includes a register programming interface, command set, and feature set definition. These NVMe features enable companies and storage manufacturers to write standard drivers for each operating system, and enable interoperability between implementations that shortens testing and qualification cycles.

NAND flash is a popular non-volatile memory used in a storage medium. Other types of non-volatile memories include phase-change memory (PCM), magnetoresistive RAM (MRAM) and resistive RAM (RRAM or ReRAM). PCM, one of the most promising emerging memory cell contenders, achieves non-volatility by re-melting a material with two distinguishable solid phases to store two or more different bit values. Discovered in 1968, this effect is today widely used in DVD-RW media, and is now making inroads into lithographed memory devices thanks to its favorable device size and scaling properties, high endurance and very fast readout. In MRAMs, data is stored in magnetic storage elements. The storage elements are formed from two ferromagnetic plates, each of which can hold a magnetic field, separated by a thin insulating layer. One of the two plates is a permanent magnet set to a particular polarity, while the other plate's field can be changed to match that of an external field to store memory. ReRAMs operate by changing the resistance of a specially formulated solid dielectric material. A ReRAM device contains a component called memory resistor (memristor), whose resistance can be modified by passing current through it.

### SUMMARY

The present disclosure relates to methods, systems, and computer program products for performing operations according to a communications protocol.

Methods and systems of performing operations in a communications protocol are provided. For example, a method of performing operations in a communications protocol can include submitting, by a target, a command request for an entry in a queue, wherein the entry in the queue represents a command inserted into the queue by a host and receiving, responsive to the command request, the entry in the queue, wherein the received entry in the queue comprises the command inserted into the queue by the host, and wherein the command comprises a request for data. The method can also include providing a first set of the requested data, responsive to the received entry in the queue, submitting a signal to the host indicating that a transmission of the requested data will complete, and providing a second set of the requested data.

According to aspects of the invention, a system for performing operations in a communications protocol can include an interface between a host and a target for transmitting data and a storage, in communication with the target, for storing and retrieving the data. The target can be configured to submit a command request for an entry in a queue, wherein the entry in the queue represents a command inserted into the queue by a host and receive, responsive to the command request, the entry in the queue, wherein the received entry in the queue comprises the command inserted into the queue by the host, and wherein the command comprises a request for data stored in storage. The target can also be configured to provide a first set of the requested data, responsive to the received entry in the queue, submit a signal to the host indicating that a transmission of the requested data will complete, and provide a second set of the requested data.

### BRIEF DESCRIPTION OF THE DRAWINGS

Various objects, features, and advantages of the present disclosure can be more fully appreciated with reference to the following detailed description when considered in connection with the following drawings, in which like reference numerals identify like elements. The following drawings are for the purpose of illustration only and are not intended to be limiting of the invention, the scope of which is set forth in the claims that follow.

FIG. 1 illustrates an example system implementing a communication protocol, in accordance with embodiments of the present disclosure.

FIGS. 2-3 illustrate example message flows of a Non-Volatile Memory Express (NVMe)-compliant read operation.

FIG. 4 illustrates an example message flow in accordance with embodiments of the present disclosure.

### DETAILED DESCRIPTION

Emerging non-volatile storage memories (NVM) can present architectural challenges. Writing to NVMs can be slow enough to make NVMs impractical for use in a main memory controller of a CPU. However, reading from NVMs can be so fast that using them in a peripheral storage device could leave much of its performance potential untapped at low command queue depths, throttled by high latencies of common peripheral buses and traditional communication and device protocols.

The present disclosure relates to systems and methods for implementing a communication protocol. The communication protocol can reduce latency in communicating with a storage device over an interface. For example, the communication protocol can explore the limits of communication latency with a NVM-based storage device over a PCI Express (PCIe) interface.

The development of NAND flash and the market adoption of flash-based storage peripherals has exposed limitations of a prior generation of device interfaces (e.g., SATA, SAS), prompting creation of an NVM Express (NVMe) protocol. NVMe is a simplified protocol for Non-Volatile Memory (NVM) storage attached to a PCI Express interface. In the course of researching the capabilities of several memory technologies vying to improve upon flash memory, Applicants set out to build NVMe-compliant prototypes as technology demonstrators. Applicants have discovered problems, however, that theoretical maximal performance permitted by traditional communication protocols such as NVMe can throttle the potential of many emerging non-volatile memory technologies.

For example, a dramatic advantage of PCM over NAND flash is that readout latency of PCM can be shorter by more than two orders of magnitude. While PCM write latency can be about fifty times longer than reads at current lithographic limits, PCM is already comparable with NAND flash and can be expected to improve further with advances in lithography. This readout latency makes PCM an attractive alternative in settings where workload is dominated by reads.

The communication protocol further allows for building a block storage device that takes advantage of the fast readout of PCM, to achieve high numbers of input-output operations per second (IOPS) permitted by the low physical latency of the storage medium. While spectacular numbers of IOPS have been touted for flash-based storage media, such performance is generally only possible at impractically high queue depths. Many practical data center usage patterns continue to revolve around low queue depths, especially under completion latency bounds. For example, an illuminating metric of device performance in many settings is round-trip latency to the storage device, as opposed to total bandwidth achievable. Total bandwidth scales easily with device bus width and speed, unlike round-trip latency. Under this more stringent criterion of round-trip latency, traditional flash-based SSDs can top out around 13 kIOPS for small random reads at queue depth 1, limited by over 70 μs of readout latency attributable to the storage medium.

Starting from traditional communication protocols such as NVMe, the communication protocol described herein proceeds to modify the interpretation of particular read-side signals and messages by efficiently scheduling packet exchanges over interfaces such as PCI Express, and by reducing mode and context switching timing costs.

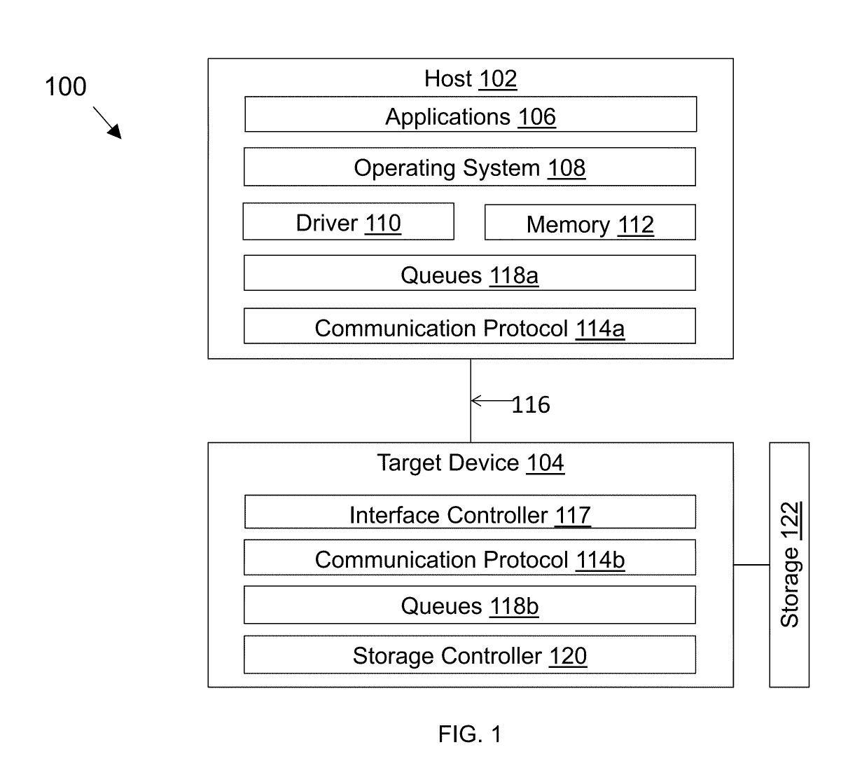

FIG. 1 illustrates an example system 100 implementing a communication protocol, in accordance with some embodiments of the present disclosure. System 100 includes host 102 in communication with target device 104 and storage 122. Host 102 includes user applications 106, operating system 108, driver 110, host memory 112, queues 118a, and communication protocol 114a. Target device 104 includes interface controller 117, communication protocol 114b, queues 118b, and storage controller 120 in communication with storage 122.

Host 102 can run user-level applications 106 on operating system 108. Operating system 108 can run driver 110 that interfaces with host memory 112. In some embodiments, memory 112 can be dynamic random access memory (DRAM). Host memory 112 can use queues 118a to store commands from host 102 for target 104 to process. Examples of stored or enqueued commands can include read operations from host 102. Communication protocol 114a can allow host 102 to communicate with target device 104 using interface controller 117.

Target device 104 can communicate with host 102 using interface controller 117 and communication protocol 114b. Communication protocol 114b can provide queues 118 to access storage 122 via storage controller 120.

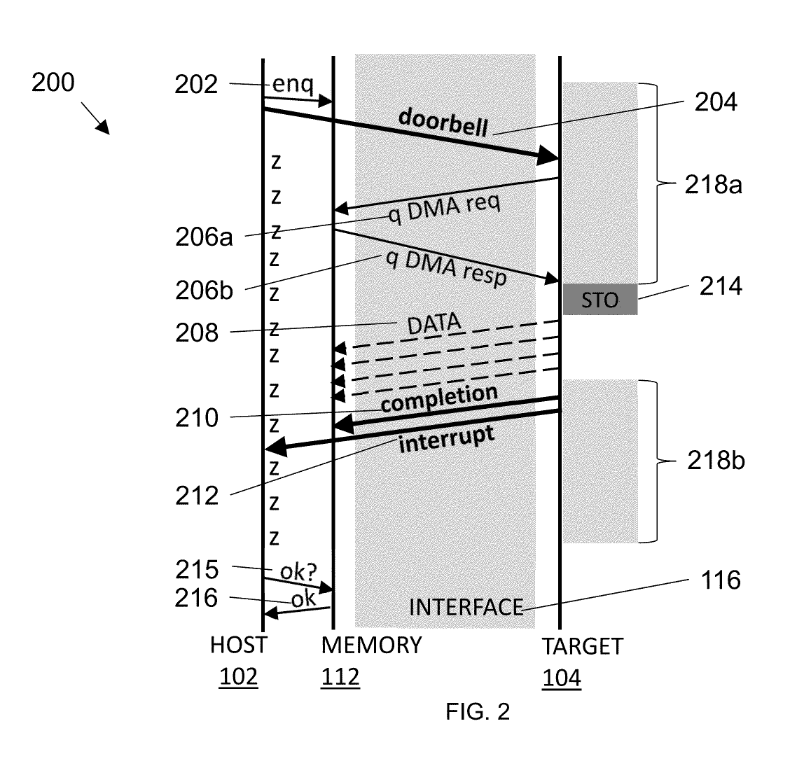

FIG. 2 illustrates an example message flow 200 of an NVM Express (NVMe) communication protocol, in accordance with some embodiments of the present disclosure. FIG. 2 illustrates host 102 in communication with host memory 112 and target 104 over interface 116.

The message flow and timing diagrams herein, including FIG. 2, are for illustrative purposes. Time is generally shown flowing down, and the illustrated timing is not to scale. The communication protocol for reading a block from target 104 can begin with host 102 preparing and enqueuing a read command in host memory 112 (step 202) and initiating the transaction by sending a “doorbell” packet (step 204) over interface 116 (e.g., PCI Express). The doorbell, also referred to herein as a command availability signal, signals the target device that there is a new command waiting, such as a read command. In response, the target device can initiate a direct memory access (DMA) request—resulting in transmission of another PCI Express packet—to retrieve the enqueued command from the queue in memory 112 (step 206a). The PCI Express packets, discussed in more detail below, can generally result in small penalties on the maximal payload bandwidth remaining A data packet can settle into the host memory 112 in atomic fashion, regardless of the type of bus or communication network used. Accordingly, the system does not need to check whether the data has settled in the host memory 112 at any finer granularity than one packet length.

Specifically, host 102 can enqueue (“enq”) a command (step 202) such as a read command, and can ring a command availability signal (“doorbell”) (step 204). In some embodiments, host 102 can include a CPU that interacts with host memory 112. The doorbell signal can represent a command availability signal that host 102 uses to indicate to the device (target 104) that a command is available in a queue in memory 112 for target 104 to retrieve. After host 102 rings the command availability signal (step 204), it can perform a content switch and work on other threads, while waiting for the requested data from target 104. In response to receiving the doorbell signal, target 104 can send a command request to retrieve the queue entry (step 206a). For example, the command request can be a direct memory access (DMA) request for the queue entry. Target 104 can receive the requested entry from the queue (step 206b). For example, target 104 can receive the DMA response from memory 112 on host 102. Target 104 can parse the command in the queue (e.g., the read command), and execute the command. For example, target 104 can send the requested data packets to memory 112 (step 208). After target 104 has completed sending the requested data, it can write an entry, or acknowledgement signal, into a completion queue (step 210). The device can further assert an interrupt that notifies the host that the device has finished writing the requested data (step 212). A thread on the CPU on host 102 can handle the interrupt. From the time the interrupt signal reaches the CPU on host 102, it takes a lot of cycles to do the context switch and carry on with the thread that was waiting for the data from target 104. Hence, the thread can be considered as if it is “sleeping” for a few microseconds after the interrupt arrives. Subsequently, when the CPU on the host 102 “wakes up,” it can query the host memory 112 to confirm that the completion signal is in fact in the completion queue (step 215). Memory 112 can respond back to the host CPU with a confirmation when the completion signal is in the completion queue (step 216).

Bars 218a-218b illustrate protocol latencies incurred due to the traditional NVMe communication protocol. These latencies can be improved by replacing the traditional NVMe communication protocol with the systems and methods described herein. Rectangle 214 illustrates an amount of time when target 104 actually reads storage 112 (e.g., PCM). The amount of time when target 104 actually reads storage 112 (rectangle 214) is relatively small compared to the time that corresponds to protocol latencies (bars 218a-218b), which indicates that the latency and overhead incurred by a traditional communication protocol such as NVMe can be overwhelming in comparison.

The discussion of message flow 200 of the NVMe communication protocol is presented for illustrative purposes. For example, message flow 200 shows host 102 initiating the transaction by sending a “doorbell” packet (step 204) over interface 116a. A person of ordinary skill in the art would understand that the embodiments of the disclosure discussed herein can be used with host-initiated transaction or target-initiated transactions, for example, the doorbell-less target-initiated transaction discussed in U.S. patent application Ser. No. 14/466,515, the contents of which are incorporated herein in their entirety.

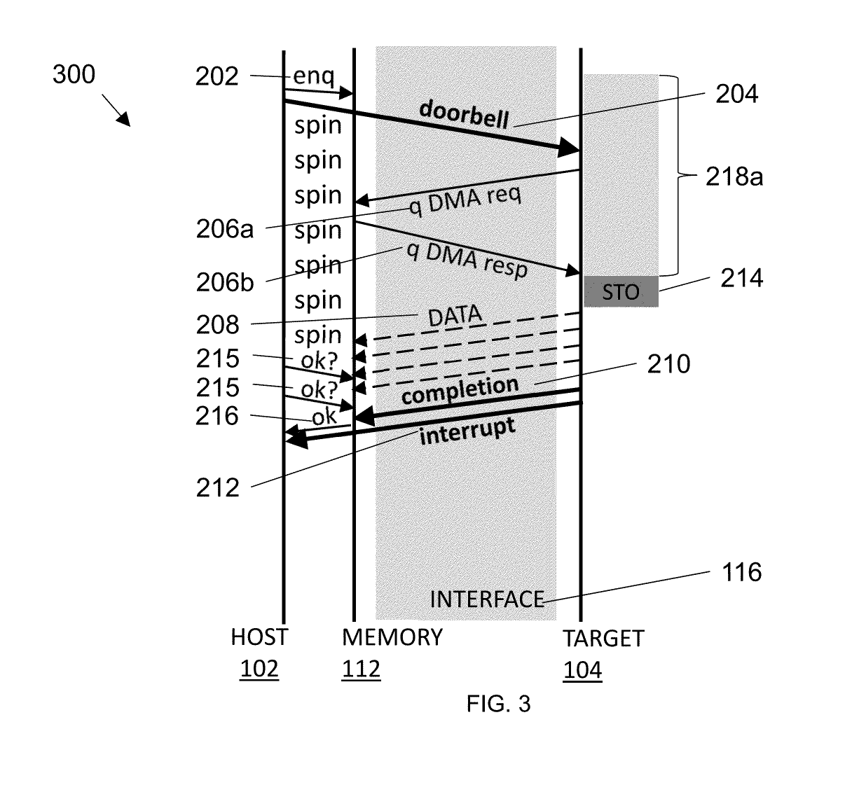

FIG. 3 shows an illustrative timing diagram 300 of an NVM Express (NVMe)-compliant read operation, that avoids the performance overhead of the interrupt-based completion signaling discussed above in association with FIG. 2. FIG. 3 illustrates host 102 in communication with target 104. In the embodiment shown in FIG. 3, host 102 does not context switch to a different thread while waiting for the data from target 104. Instead, it enters into a spin-wait mode waiting for the completion of the data transfer. The CPU on the host 102 can query the host memory 112 to detect when a completion signal is in fact in the completion queue (step 215). Memory 112 can respond back to the host CPU with a confirmation when the completion signal is in the completion queue (step 216) to inform the host that the data has been copied into memory 112.

One concern with the protocol discussed above is the waste of resources during the spin-wait. Because there is no context switching, host 102 does not perform any useful computation on other threads, while waiting for the completion of the data transfer.

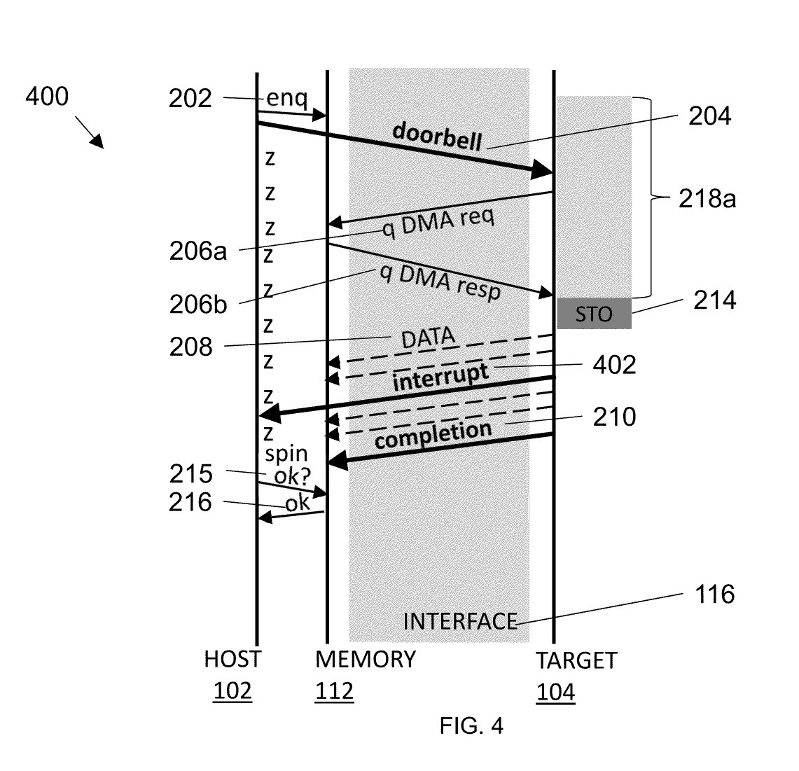

FIG. 4 shows an illustrative timing diagram 400 of the communication protocol, in accordance with some embodiments of the present disclosure. Message flow 400 includes host 102 in communication with target 104. Target 104 can send a command request to retrieve the queue entry (step 206a). As discussed above, target 104 can receive the requested entry from the queue (step 206b), can parse the command in the queue (e.g., the read command), and start sending the requested data. Target 104 can send the data in-order or out-of-order. While target 104 sends the data to memory 112, host 102 can execute commands from a different thread. Accordingly, host 102 does not need to spin-wait while waiting for the requested data.

According to aspects of the present disclosure, target 104, for example the target device interface controller 117, can estimate the remaining time for transmitting the requested data over interface 116. Target 104 can interrupt the transmission of data to send a control signal to host 102, for example, interrupt signal (step 402), to inform the host that the transmission of the requested data is close to completion. When host 102 receives the control signal 402 from the target, the signal will be an indication to the host 102 that the transmission of the requested data will soon be completed. Accordingly, the host 102 can determine whether and/or when it will context switch to the thread that had requested the data from target 104. For example, target 104 can estimate the remaining time for transmitting the requested data by speculative, empirical, or observational techniques. Target 104 can also use adaptive algorithms, heuristics, and statistics, for example, stochastic distributions, to estimate the remaining time for transmitting the requested data.

Target 104 can schedule the sending of the control signal 212, such that, after host 102 completes the context switch to the thread that had requested the data, host 102 does not enter a spin-wait mode for a long period of time. For example, target 104 can calculate the time required for completing of sending the requested data and the time host 102 requires for context switching. Preferably, target 104 can schedule the transmission of the control signal, such that the host returns to the thread that requested the data, when the acknowledgement signal of the completion of the transfer has been registered into the completion queue (step 210).

Those of skill in the art would appreciate that the various illustrations in the specification and drawings described herein can be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware, software, or a combination depends upon the particular application and design constraints imposed on the overall system. Skilled artisans can implement the described functionality in varying ways for each particular application. Various components and blocks can be arranged differently (for example, arranged in a different order, or partitioned in a different way) all without departing from the scope of the subject technology.

Furthermore, an implementation of the communication protocol can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The methods for the communications protocol can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this communications protocol can be embodied in other specific forms without departing from the spirit or essential attributes thereof, and accordingly, reference should be had to the following claims, rather than to the foregoing specification, as indicating the scope of the invention.

The communications protocol has been described in detail with specific reference to these illustrated embodiments. It will be apparent, however, that various modifications and changes can be made within the spirit and scope of the disclosure as described in the foregoing specification, and such modifications and changes are to be considered equivalents and part of this disclosure.

What is claimed is:

1. A method of performing operations in a communications protocol, the method comprising:
submitting, by a target, a command request for an entry in a queue, wherein the entry in the queue represents a command inserted into the queue by a host;
receiving, by the target responsive to the command request, the entry in the queue, wherein the received entry in the queue comprises the command inserted into the queue by the host, and wherein the command comprises a request for data;
providing, by the target, a first set of the requested data, responsive to the received entry in the queue;
submitting, by the target, a signal to the host indicating that a transmission of the requested data will complete; and
providing, by the target, a second set of the requested data.

2. The method of claim 1, further comprising submitting, by the target, a completion entry to a normal completion queue on the host.

3. The method of claim 2, wherein the completion entry is submitted after submitting the signal to the host.

4. The method of claim 1, further comprising estimating, by the target, a remaining time for completing providing the second set of the requested data.

5. The method of claim 4, wherein submitting the signal to the host is scheduled based on the estimated remaining time for completing providing the second set of the requested data.

6. The method of claim 4, wherein estimating the remaining time includes using at least one of a speculative technique, an empirical technique, an observational technique, an adaptive algorithm, a heuristic algorithm, and a statistic algorithm.

7. The method of claim 1, wherein the target is coupled to a storage for storing and retrieving the requested data.

8. The method of claim 7, wherein the storage includes at least one of a phase-change memory (PCM), a magnetoresistive RAM (MRAM) and a resistive RAM (RRAM or ReRAM).

9. The method of claim 1, wherein providing the first set of the requested data and the second set of the requested data includes providing the first set of the requested data out-of-order and the second set of the requested data out-of-order.

10. The method of claim 1, wherein the communication protocol includes commands with command formats compatible with the Non-Volatile Memory Express standard.

11. A system for performing operations in a communications protocol, the system comprising:
an interface between a host and a target for transmitting data; and
a storage, in communication with the target, for storing and retrieving the data;
wherein the target is configured to:
submit a command request for an entry in a queue, wherein the entry in the queue represents a command inserted into the queue by a host;
receive, responsive to the command request, the entry in the queue, wherein the received entry in the queue comprises the command inserted into the queue by the host, and wherein the command comprises a request for data stored in storage;
provide a first set of the requested data, responsive to the received entry in the queue;
submit a signal to the host indicating that a transmission of the requested data will complete; and
provide a second set of the requested data.

12. The system of claim 11, wherein the target is further configured to submit a completion entry to a normal completion queue on the host.

13. The system of claim 12, wherein the completion entry is submitted after submitting the signal to the host.

14. The system of claim 11, wherein the target is further configured to estimate a remaining time for completing providing the second set of the requested data.

15. The system of claim 14, wherein the target is further configured to submit the signal to the host based on the estimated remaining time.

16. The system of claim 14, wherein the target is further configured to estimate the remaining time using at least one of a speculative technique, an empirical technique, an observational technique, an adaptive algorithm, a heuristic algorithm, and a statistic algorithm.

17. The system of claim 11, wherein the storage includes at least one of a phase-change memory (PCM), a magnetoresistive RAM (MRAM) and a resistive RAM (RRAM or ReRAM).

18. The system of claim 11, wherein the target is configured to provide the first set of the requested data out-of-order and the second set of the requested data out-of-order.

19. The system of claim 11, wherein the communication protocol includes commands with command formats compatible with the Non-Volatile Memory Express standard.
